(19) United States
(12) Patent Application Publication
(10) Pub. No.: US 2019/0368067 A1
(43) Pub. Date: Dec. 5, 2019

(54) RATCHET WHEEL AND METHOD FOR MAKING THE SAME

(71) Applicant: YI-FU CHEN, TAICHUNG CITY (TW)

(72) Inventor: YI-FU CHEN, TAICHUNG CITY (TW)

(21) Appl. No.: 16/199,561

(22) Filed: Nov. 26, 2018

Related U.S. Application Data
(62) Division of application No. 15/990,826, filed on May 29, 2018.

(51) Int. Cl. C25D 5/02; F16H 31/00; F16H 55/06; C25D 7/04; F16H 55/17; C25D 5/10; B25B 13/46

(52) U.S. Cl. CPC C25D 5/022; F16H 31/004; F16H 55/06; B25B 13/463; F16H 55/17; C25D 5/10; C25D 7/04

(57) ABSTRACT

A ratchet wheel includes an outer surface multiple ratchet teeth formed thereon, an inner surface having a polygonal hole defined therein, a first end and a second end. An electro-plating process is applied to the ratchet wheel to form a protective layer plated on the whole ratchet wheel. The protective layer is a durable and high stiffness metal layer or an alloy layer. An isolation layer is coated to the outer surface of the ratchet wheel, and a recognition layer is formed on the protective layer on the inner surface, the first end and the second end of the ratchet wheel.

The present invention is a divisional patent application of U.S. patent application Ser. No. 15/990,826, filed on May 29, 2018, and relates to a ratchet wheel with a protective layer and a recognition layer.

### BACKGROUND OF THE INVENTION

### 1. Fields of the Invention

### 2. Descriptions of Related Art

The conventional tool parts are coated with a layer with a specific color for recognition purpose, and the coated layer also allows the users to quickly tell which specification system (Metric system or English system) that the tool parts uses.

However, the coated layer is easily peeled off from the tool parts. Besides, the coated layer cannot be applied to the whole surface of the tool parts, and this is because the coated layer may be peeled off and affects engagement between the tool parts. Therefore, the conventional tool parts do not have the coated layer at the surfaces that are applied with forces, for example the ratchet teeth and the mounting hole.

The present invention is intended to provide a ratchet wheel that is designed to eliminate the drawbacks mentioned above. The present invention is also intended to provide a method for making the ratchet wheel.

### SUMMARY OF THE INVENTION

The present invention relates to a method for making a ratchet wheel and the ratchet wheel comprises an outer surface, an inner surface, a first end and a second end. The first and second surfaces are respectively connected to two ends of the outer surface and the inner surface. The outer surface includes multiple ratchet teeth formed thereon, and the inner surface includes a polygonal hole defined therein. A protective layer is plated on the whole ratchet wheel. The protective layer is a durable and high stiffness metal layer or an alloy layer. The protective layer is plated to the outer surface including the surfaces of the ratchet teeth on the outer surface, the inner surface including the surface of the polygonal hole, and the first and second ends. A recognition layer is formed on the protective layer on the inner surface, the first end and the second end of the ratchet wheel.

The advantages of the present invention are that the protective layer is plated to the whole surface of the whole ratchet wheel, and the recognition layer is coated to the protective layer to provide information or features of the ratchet wheel.

The protective layer is tightly plated to the whole surface of the ratchet wheel, and the protective layer is smooth and is not peeled off. The protective layer enhances the durability of the ratchet wheel and prevents the ratchet wheel from being oxidized. The protective layer is plated to the surface of the ratchet teeth and enhances stiffness, durability and stability of the ratchet teeth.

The recognition layer allows the users to quickly recognize the specification and size of the ratchet wheel by the color of the recognition layer.

The recognition layer is plated onto the protective layer, and the recognition layer is not peeled off.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the ratchet wheel of the present invention having the protective layer;

FIG. 2 is a cross sectional view to show the ratchet wheel of the present invention disclosed in FIG. 1;

FIG. 3 is an enlarged cross sectional view of the circled “A” in FIG. 2 of the ratchet wheel of the present invention;

FIG. 4 is a cross sectional view to show the ratchet wheel of the present invention having the isolation layer;

FIG. 5 shows that the ratchet wheel in FIG. 4 receives the secondary electro-plating process;

FIG. 6 is a cross sectional view to show the ratchet wheel of the present invention having both of the protective layer and the isolation layer;

FIG. 7 is an enlarged cross sectional view of the circled “B” in FIG. 6 of the ratchet wheel of the present invention, and

FIG. 8 is a perspective view to show the ratchet wheel of the present invention having both of the protective layer and the isolation layer.

### DETAILED DESCRIPTION OF THE PREFERRED EMBODIMENT

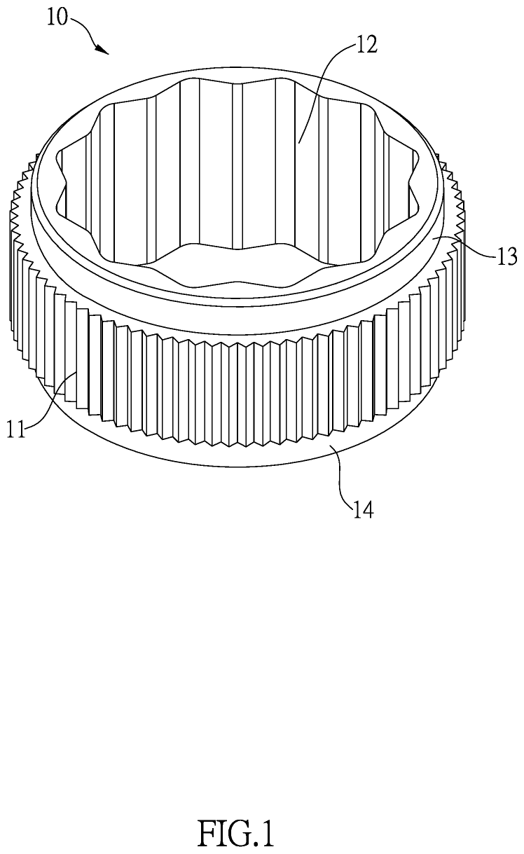

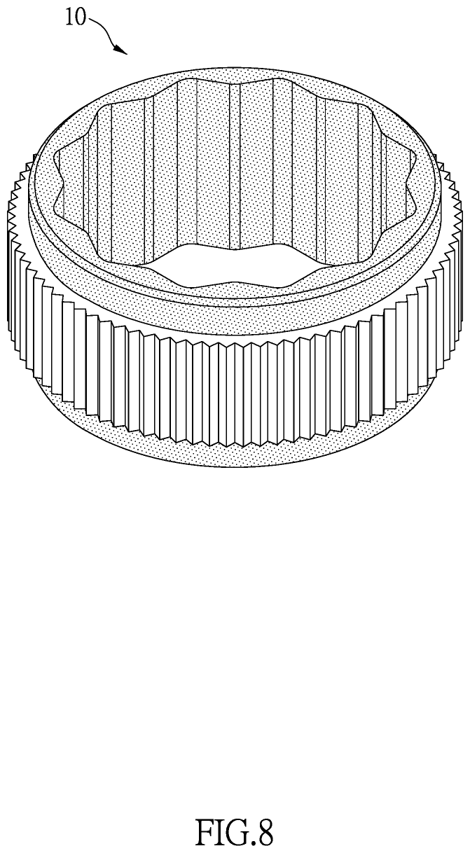

Referring to FIGS. 1 to 8, the method for making the ratchet wheel 10 of the present invention comprises the following steps:

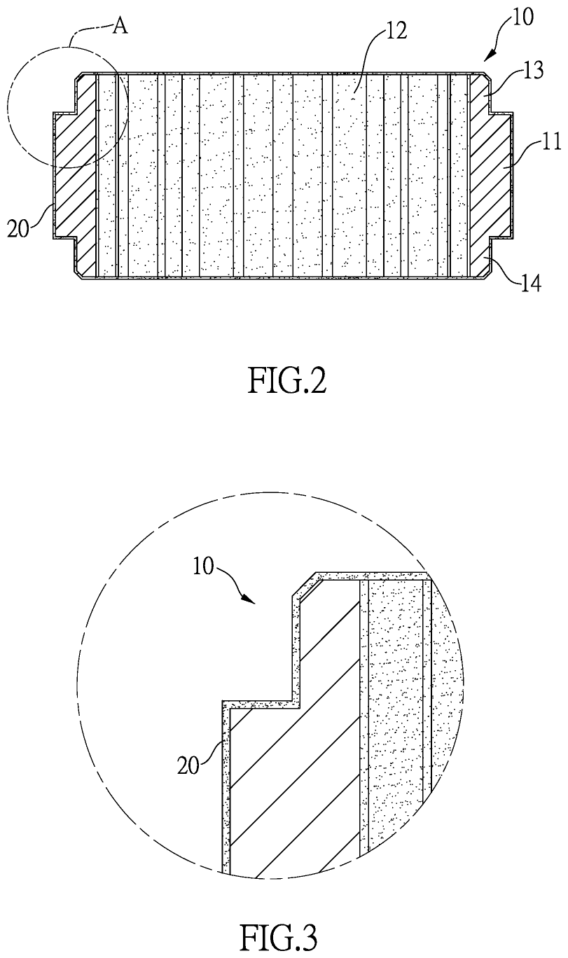

A step of first plating: The ratchet wheel 10 includes an outer surface 11, an inner surface 12, a first end 13 and a second end 14. The first and second end surfaces 13, 14 are respectively connected to two ends of the outer surface 11 and the inner surface 12. The outer surface 11 has multiple ratchet teeth formed thereon, and the inner surface 12 has a polygonal hole defined therein. The ratchet wheel 10 is put into a plating liquid and an electro-plating process is applied to the ratchet wheel 10 to form a protective layer 20 plated on the whole ratchet wheel 10 as shown in FIGS. 2 and 3. The protective layer 20 is a durable and high stiffness metal layer or an alloy layer. The protective layer 20 is plated to the outer surface 11 including the surfaces of the ratchet teeth on the outer surface 11, the inner surface 12 including the surface of the polygonal hole, and the first and second ends 13, 14.

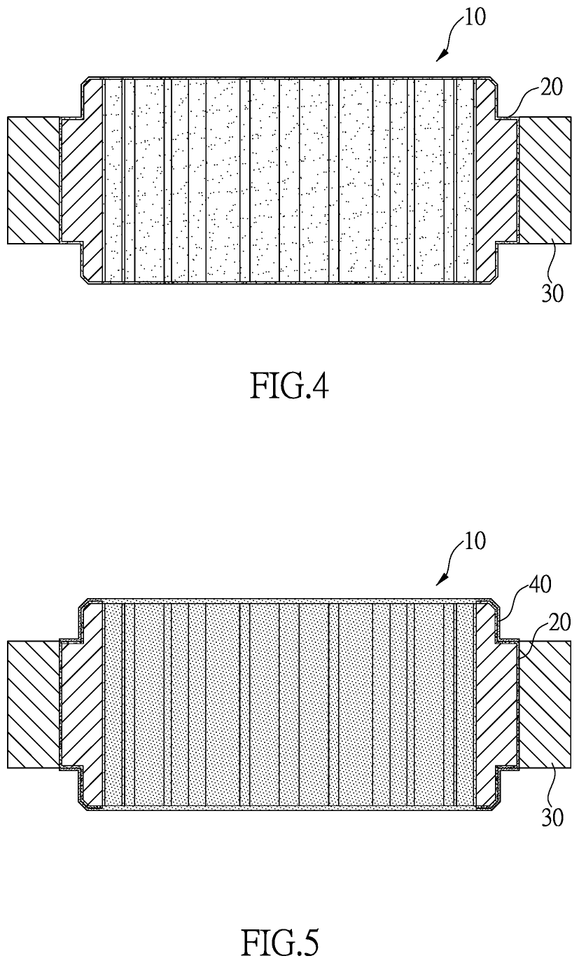

A step of applying an isolation layer: The ratchet wheel 10 is removed from the plating liquid in the previous step, and dried. An isolation layer 30 is coated to the outer surface of the ratchet wheel as shown in FIGS. 4 and 5.

A step of secondary plating: Another electro-plating process is applied to the ratchet wheel 10 with the isolation layer 30 so as to form a recognition layer 40 on the protective layer 20 on the inner surface 11, the first end 13 and the second end 14 of the ratchet wheel 10 as shown in FIG. 5. The recognition layer 40 has a color.

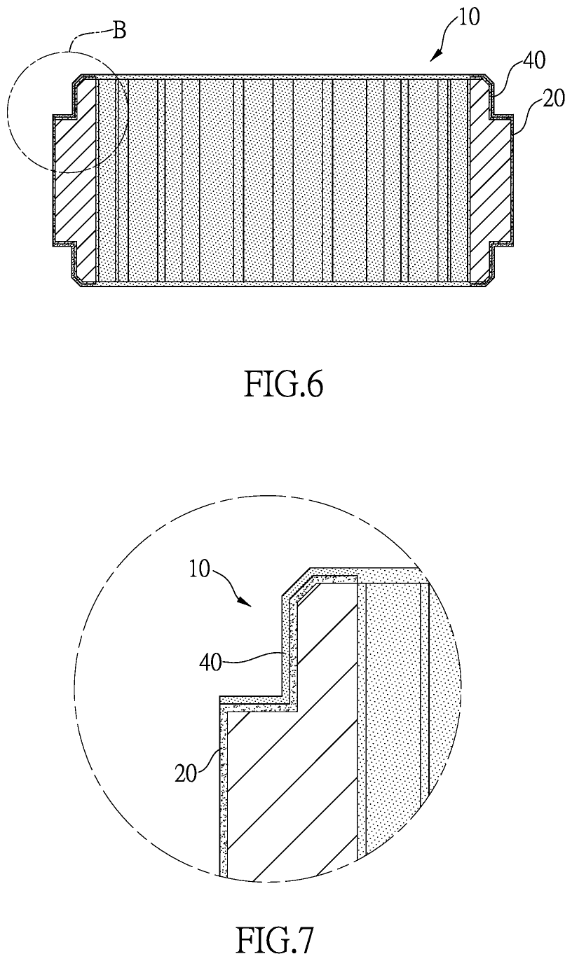

A step of removing the isolation layer: The ratchet wheel 10 is removed from the plating liquid of the secondary plating and dried, and the isolation layer 30 is then removed from the ratchet wheel 10 as shown in FIG. 6.

As shown in FIGS. 6, 7 and 8, the ratchet wheel 10 has the protective layer 20 and the recognition layer 40, wherein protective layer 20 is plated to the whole ratchet wheel 10, and the recognition layer 40 is plated on the protective layer 20 of the inner surface 12, the first end 13 and the second end 14.

The protective layer 20 is plated to the whole surface of the whole ratchet wheel 10, and the recognition layer 40 is coated to the protective layer 20 to provide information or features of the ratchet wheel. The protective layer 20 is tightly plated to the whole surface of the ratchet wheel 10, and the protective layer 20 is smooth and is not peeled off. The protective layer 20 enhances the durability of the ratchet wheel 10 and prevents the ratchet wheel 10 from being oxidized. The protective layer 20 also is plated to the surface of the ratchet teeth to enhance stiffness, durability and stability of the ratchet teeth 10. The recognition layer 40 allows the users to quickly recognize the specification and size of the ratchet wheel 10 by the color of the recognition layer 40. The recognition layer 40 is plated onto the protective layer 20, and the recognition layer 40 is not peeled off.

While we have shown and described the embodiment in accordance with the present invention, it should be clear to those skilled in the art that further embodiments may be made without departing from the scope of the present invention.

What is claimed is:

1. A ratchet wheel comprising:
an outer surface, an inner surface, a first end and a second end, the first and second surfaces respectively connected to two ends of the outer surface and the inner surface, the outer surface including multiple ratchet teeth formed thereon, the inner surface including a polygonal hole defined therein, a protective layer plated on the whole ratchet wheel, the protective layer being a durable and high stiffness metal layer or an alloy layer, the protective layer being plated to the outer surface including surfaces of the ratchet teeth on the outer surface, the inner surface including a surface of a polygonal hole, and the first and second ends, a recognition layer formed on the protective layer on the inner surface, the first end and the second end of the ratchet wheel.
